(19) United States
(12) Patent Application Publication
(10) Pub. No.: US 2025/0361948 A1
(43) Pub. Date: Nov. 27, 2025

(54) VALVE

(71) Applicant: VAT Holding AG, Haag (CH)

(72) Inventor: Peter ZVOKELJ, Höchst (AT)

(73) Assignee: VAT Holding AG, Haag (CH)

(21) Appl. No.: 18/873,820

(22) PCT Filed: May 8, 2023
(86) PCT No.: PCT/EP2023/062095

§ 371 Date: Dec. 11, 2024

(30) Foreign Application Priority Data
Jun. 13, 2022 (DE) 10 2022 114 809.2

(51) Int. Cl. F16K 31/04; F16K 1/36; F16K 51/02

(52) U.S. Cl. CPC F16K 31/047; F16K 1/36; F16K 51/02

(57) ABSTRACT

A valve (1), in particular a vacuum valve, for metering a volume flow through a flow opening (2). The valve (1) has a valve plate (3) for closing the flow opening (2) in a closed position of the valve (1) and at least two valve rods (4, 5), each of which is elongate, wherein the valve rods (4, 5) are secured to the valve plate (3) at mutually spaced locations. Each of the valve rods (4, 5) is driven in a linearly movable manner by a dedicated valve drive (6, 7) of the valve (1) in order to adjust the valve plate (3), and only a subset of the valve rods (4) are driven in a linearly movable manner by the valve drive (6) thereof over the entire movement path (10) of the valve plate (3) between the closed position and the maximum open position.

### CROSS-REFERENCE TO RELATED APPLICATIONS

This application is a 371 National Phase of International Application No. PCT/EP2023/062095, filed May 8, 2023, which claims priority from German Patent Application No. 10 2022 114 809.2, filed Jun. 13, 2022, both of which are incorporated herein by reference as if fully set forth.

### TECHNICAL FIELD

The present invention relates to a valve, in particular a vacuum valve, for metering a volumetric flow through a flow opening, wherein the valve has a valve plate for closing the flow opening in a closed position of the valve, and at least two valve rods which are in each case elongate, wherein the valve rods are fastened to the valve plate at mutually spaced apart locations, and each of the valve rods is driven by a dedicated valve drive of the valve in a linearly displaceable manner so as to adjust the valve plate.

### BACKGROUND

Valves of this type are in particular used in vacuum technology for metering a volumetric flow, thus the inflow or the outflow of a fluid, in particular of a gas, through a flow opening. In most instances, these are flow openings through which an inflow or outflow of the fluid to or from a process chamber takes place. The volumetric flow through the flow opening can be well metered with such valves. A valve of this type is shown, for example, in FIGS. 5a and 5b of U.S. Pat. No 10,156,299 B2.

### SUMMARY

It is an object of the invention to provide a valve of the type mentioned at the outset, which has a reduced energy requirement.

This is achieved by a valve having one or more of the features disclosed herein.

It is thus provided according to the invention that only a subset of the valve rods are driven by their valve drive in a linearly displaceable manner over the entire adjustment path of the valve plate between the closed position and the maximum open position.

It is particularly preferably provided that only one of the valve rods is driving by its valve drive in a linearly displaceable manner over the entire adjustment path of the valve plate between the closed position and the maximum open position.

In this way, in the invention only a subset of the valve drives, preferably only one of the valve drives, is active over the entire adjustment path of the valve drive, as a result of which the valve can be operated in a particularly energy-saving manner. Moreover, such valves are comparatively cost-effective to produce.

It is favorably provided that the valve rods are driven by their respective valve drives exclusively in a linearly displaceable manner.

It is favorably provided in the invention that at least one of the valve rods is driven by its valve drive in a linearly displaceable manner only over a partial distance of the adjustment path of the valve plate toward the closed position and away from the closed position.

This can be implemented, for example, in that the at least one of the valve rods, which is driven by its valve drive in a linearly displaceable manner only over a partial distance of the adjustment path of the valve plate toward the closed position and away from the closed position, is uncoupled from its valve drive on another partial distance of the adjustment path of the valve plate toward the maximum open position and away from the maximum open position. In such design embodiments of the invention, the linear drive for the at least one of the valve rods, which is driven by its valve drive in a linearly displaceable manner only over a partial distance of the adjustment path of the valve plate toward the closed position and away from the closed position, is thus active only for pressing the valve plate onto the valve seat and/or for lifting the valve plate from the valve seat. The remainder of the movement of the valve plate is implemented exclusively by way of the valve drive of the other valve rod, or valve rods.

The valve rods can fundamentally consist of different materials. It can also be provided that one of the valve rods consists of a first material, and the other valve rod or valve rods consists/consist of a different material. However, preferred variants of the invention provide that the valve rods are formed from the same material, preferably steel. The valve rods preferably consist of a steel, in particular high-grade steel.

Valves of this type are typically installed in such a way that the valve plate is located in the process chamber and the valve drives are located outside the process chamber. There is in most instances a temperature difference prevalent between the region within the process chamber and the region outside the process chamber, so that there is the requirement of compensating the thermal deformations generated by the temperature difference, in particular without particles being created as a result, or the creation of particles being ideally avoided, in the process.

In valves according to the invention, a compensation element for compensating such thermally generated deformations can be inserted between at least one of the valve rods and the valve plate.

In this context, other valves according to the invention can provide that the valve rods are designed with a different stiffness in terms of a deflection transverse to their respective longitudinal extent. In this variant of the invention, a temperature-related elongation of the valve plate can be compensated for in that the valve rod which is less stiff in terms of a deflection transverse to its longitudinal extent is deflected to a greater degree than the valve rod which is stiffer in terms of a deflection transverse to its longitudinal extent. Owing to this fact, differences in the temperature-related elongation in and outside the process chamber can be particularly well compensated for, without particles being generated as a result.

The different stiffnesses of the valve rods can be achieved, for example, by using different materials. However, it is preferably provided that the valve rods at least in regions have a different diameter. In this context it is to be noted, of course, that valve rods which have the same stiffness transverse to their respective longitudinal extent may also have a different diameter.

Irrespective of how this is implemented, it is in any case preferably provided that the valve rod which is stiffer in terms of the deflection transverse to its longitudinal extent has a modulus of resistance that is at least five times that of the other valve rod, or in other words that of the valve rod that is less stiff in terms of the deflection transverse to its longitudinal extent.

The modulus of resistance herein is a measure of the mechanical resistance that the respective valve rod exerts under load. In the present case, which relates to the deflection of the valve rods transverse to their respective longitudinal extent, the modulus of resistance could also be referred to as an axial modulus of resistance or a flexural modulus of resistance.

It is preferably provided that only the valve rod which is stiffer in terms of its deflection transverse to its longitudinal extent is driven by its valve drive in a linearly displaceable manner over the entire adjustment path of the valve plate between the closed position and the maximum open position.

In the context of a linguistic simplification, the valve rod which is stiffer in terms of its deflection transverse to its longitudinal extent can also be simply referred to in short as the stiffer valve rod. In the context of a linguistic simplification, the valve rod which is less stiff in terms of its deflection transverse to its longitudinal extent can also be simply referred to in short as the less stiff valve rod.

In the implementation of the invention, all linear valve drives which are known per se can in principle be used as valve drives. Therefore, these can be hydraulic, pneumatic, or else electric valve drives.

It is again favorable here when the valve drives of the valve rods are mutually synchronized over partial distances of the adjustment path on which said valve rods are conjointly active. The synchronization can be implemented by an electronic, or a controlled, coupling of the valve drives. In pneumatic and/or hydraulic valve drives, this can however also be implemented by corresponding hydraulic or pneumatic connecting lines.

The flow opening is favorably surrounded by a valve seat onto which the valve plate is pressed when the latter in its closed position closes the flow opening. The valve seat can be part of the valve, or part of a valve seat plate which in turn is part of the valve. However, the valve seat could also be formed directly on a chamber wall of a process chamber.

### BRIEF DESCRIPTION OF THE DRAWINGS

Further features and details of preferred embodiments will be explained hereunder by way of example in the description of the figures in which:

FIGS. 1 to 11 show illustrations pertaining to a first exemplary embodiment of the invention;

FIGS. 12 to 22 show illustrations pertaining to a second exemplary embodiment of the invention;

FIGS. 23 to 26 show illustrations pertaining to a third exemplary embodiment of the invention;

FIGS. 27 to 30 show illustrations pertaining to a fourth exemplary embodiment of the invention;

FIGS. 31 to 34 show illustrations pertaining to a fifth exemplary embodiment of the invention; and

FIGS. 35 to 38 show illustrations pertaining to a sixth exemplary embodiment of the invention.

### DETAILED DESCRIPTION

The valves 1 according to the invention, as well as the exemplary embodiments shown here, are preferably so-called vacuum valves. Vacuum valves are typically used when intending to operate in a special atmosphere and/or at a special pressure level. Vacuum valves are referred to in particular when operating at pressure differences of less than or equal to 0.001 mbar (millibar), or 0.1 Pascal. However, vacuum valves may also already be referred to when they are conceived for pressure differences below normal pressure, thus below 1 bar. All valves 1 shown in the exemplary embodiments here can be used as vacuum valves.

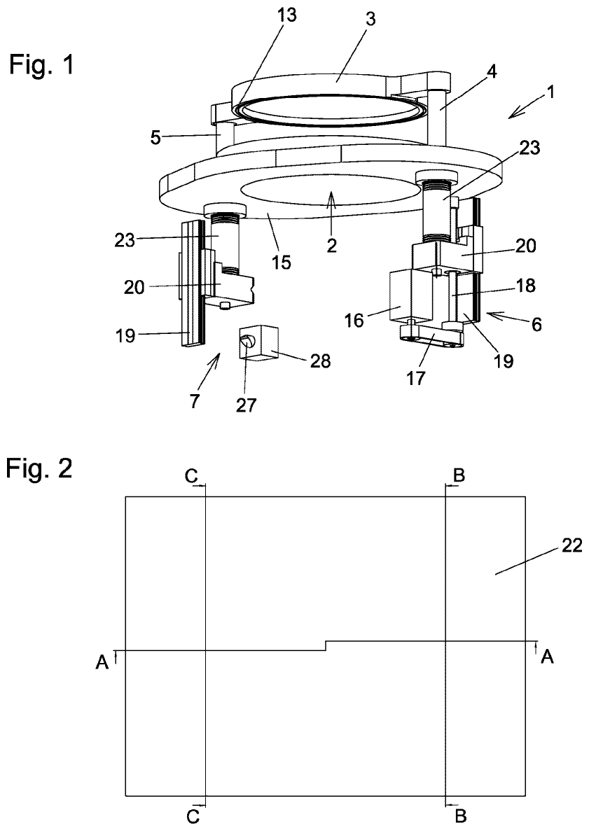

FIG. 1 now shows the valve 1 of the first exemplary embodiment, detached from the process chamber 22, in a perspective illustration, wherein the valve plate 3 is in the maximum open position. Two valve rods 4 and 5 are fastened to the valve plate 3. Each valve rod 4, 5 is assigned a dedicated valve drive 6 and 7, respectively.

In all variants of the invention discussed hereunder, and thus also in the first exemplary embodiment according to FIGS. 1 to 11, it is provided that only a subset of the valve rods 4, 5 are driven by their valve drive 6 or 7, respectively, in a linearly displaceable manner over the entire adjustment path 10 of the valve plate 3 between the closed position and the maximum open position. In the exemplary embodiments shown here, the subset consists in each case of only one valve rod 4. This is however not mandatory. The subset mentioned can also consist of two or more valve rods. In the exemplary embodiments discussed hereunder, the valve rod 5 is in each case driven by its valve drive 7 in a linearly displaceable manner only over a partial distance 11 of the adjustment path 10 of the valve plate 3 toward the closed position and/or away from the closed position. In all exemplary variants of embodiment discussed here, the valve rod 5 is uncoupled from its valve drive 7 for the remaining other partial distance 12 of the adjustment path 10.

In the first exemplary embodiment according to FIGS. 1 to 11, both valve rods 4 and 5 have the same diameter 8 and 9, respectively. In this first exemplary embodiment, said two valve rods 4 and 5 are also designed with the same stiffness in terms of a deflection transverse to their respective longitudinal extent.

For closing the flow opening 2, the valve plate 3 can be moved to the closed position and just as well to the maximum open position and to the intermediate positions disposed therebetween by means of the valve drive 6, so as to meter the volumetric flow of fluid, either a gas or a liquid, flowing through the flow opening 2.

The valve drive 6 is a spindle drive which is known per se. In this exemplary embodiment here it is specifically implemented in such a way that the valve rod 4 at its end that faces away from the valve plate 3 is fastened to a slide 20, wherein this slide 20 is mounted so as to be linearly displaceable on a guide rail 19. The valve drive 6 has a dedicated motor, presently an electric motor 16. The electric motor 16 by way of a belt drive 17 drives a spindle 18 in a manner which is known per se. A spindle nut 21 which engages in the external thread of the spindle 18 is located in the slide 20. In this way, the valve drive 6 by means of the motor 16 can displace the valve rod 4 in the direction parallel to its longitudinal extent along the guide rail 19. The rod seal 23, which surrounds the valve rod 4, ensures sealing in relation to the chamber interior 25. Corresponding rod seals 23 and spindle drive are known per se and need not be explained in more detail.

Of course, the type of the valve drive 6 implemented here could also be replaced by other suitable electric, pneumatic or hydraulic linear drives.

The valve drive 7 for the valve rod 5 has a drive pin 27 and a pin drive 28 which linearly displaces the latter. An oblique face 29, which in the coupled state presses against a mating oblique face 30 in the slide 20 of the valve rod 5, is located on the front end of the drive pin 27. By deploying the drive pin 27 by means of the pin drive 28, the valve rod 5 in the coupled state is thus also pulled in the direction toward the closed position of the valve plate 3. For opening, the drive pin 27 is retracted so far that the latter releases the slide 20 so that the valve plate 3 can then be moved to the intermediate position and also to the maximum open position exclusively by means of the valve rod 4 and its valve drive 6.

It is favorably provided that the valve drives 6 and 7 of the valve rods are mutually synchronized over partial distances 11 of the adjustment path 10 on which they are conjointly active. In the exemplary embodiments shown here, this can be implemented, for example, by a corresponding electrical activation of the valve drives 6 and 7, which is not explicitly plotted here. In the case of pneumatic or hydraulic drives, this could also be implemented by a correspondingly controlled supply of pressure.

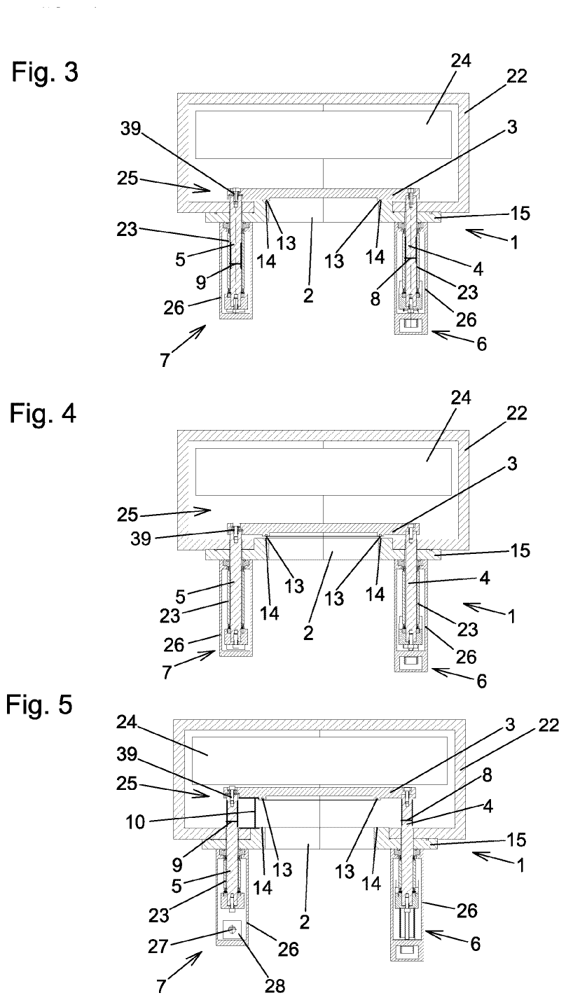

In this first exemplary embodiment, just as in the other exemplary embodiments shown, the flow opening 2 is formed in a valve seat plate 15 and, as shown in FIGS. 3, 4 and 5, also in the corresponding process chamber 22. In the exemplary embodiments shown here, the valve seat 14 against which the valve plate 3 is pressed in the closed position is located in the valve seat plate 15. The valve seat 14 and the valve seat plate 15 in these exemplary embodiments are thus part of the valve 1. However, it could just as well be provided that the valve seat plate 15 is dispensed with. In this instance, the valve seat 14 could be formed in a chamber wall of the process chamber 22 that surrounds the flow opening 2. In the exemplary embodiment shown, a seal 13 for sealing the flow opening 2 in the closed position of the valve plate 3 is located in the valve plate 3. However, corresponding seals 13 could of course also be implemented in the valve seat 14, or in the valve plate 3 as well as in the valve seat 14.

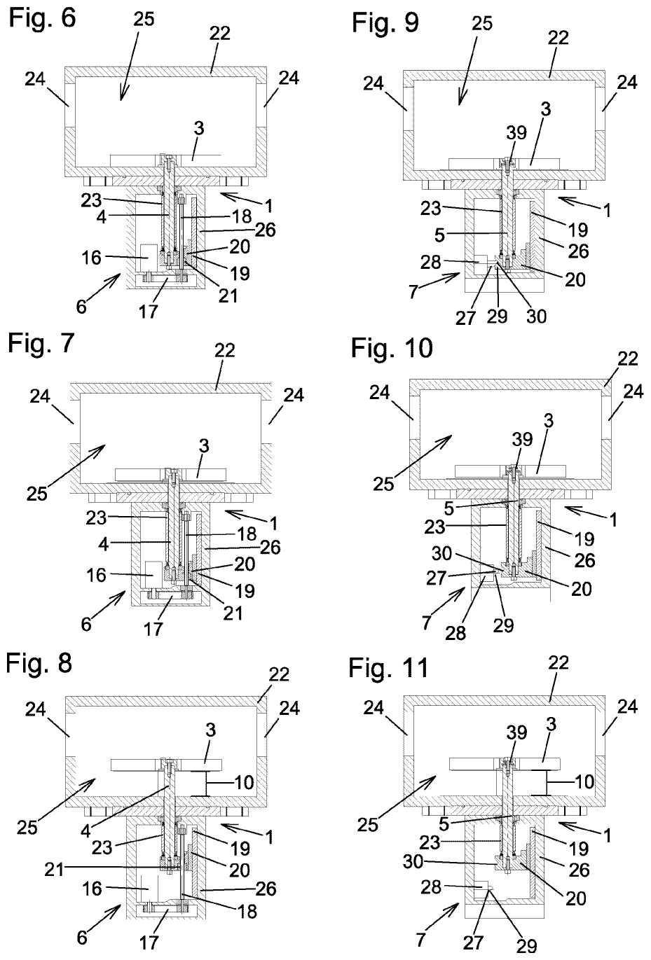

FIG. 2, pertaining to the first exemplary embodiment, now shows a top view of a schematically illustrated process chamber 22, the valve 1 from FIG. 1, which is correspondingly not visible in FIG. 2, being disposed on the lower side of said process chamber 22. In the top view according to FIG. 2, only the section lines AA, BB and CC are plotted. FIGS. 3 to 5 show sections along the section line AA, wherein the valve plate 3 of the valve 1 is in the closed position in FIG. 3, in an intermediate position in FIG. 4, and in a maximum open position in FIG. 5. FIGS. 6 to 8 show sections along the section line BB, wherein the valve plate 3 is again in the closed position in FIG. 6, in an intermediate position in FIG. 7, and in the maximum open position in FIG. 8. FIGS. 9 to 11 show sections along the section line CC, the valve plate 3 again being in the closed position in FIG. 9, in an intermediate position in FIG. 10, and in the maximum open position in FIG. 11. Moreover, it can be readily seen in FIGS. 3 to 11 that the valve drives 6 and 7 by way of their drive housings 26 are located outside the chamber interior 25 of the process chamber 22, while the valve plate 3 in all its positions is always disposed in the chamber interior 25. Typically, a different temperature level prevails in the chamber interior 25 than outside the process chamber 22. The valve plate 3 has the temperature of the chamber interior 25, while the valve drives 6 and 7 substantially have the temperature outside the process chamber 22. If the temperatures in the chamber interior 25 and in the process chamber 22 change relative to one another, a longitudinal variation which is thermally caused arises in the valve plate 3, or else in the valve drives 6 and 7. These different temperature-related elongations are compensated for by means of the compensation element 39 in this first exemplary embodiment. This compensation element 39 in this exemplary embodiment is disposed between the valve rod 5 and the valve plate 3. Said compensation element 39 allows a relative displacement between the valve rod 5 and the valve plate 3 in the longitudinal direction of the valve plate 3. As a result, the temperature-related different expansions can be very well compensated for, without particles being generated. The compensation element 39 can be, for example, an elastically deformable intermediate layer, for example of metal or elastomer, which precisely allows a corresponding relative movement. Of course, additionally or alternatively, the compensation element 39 could also be disposed between the valve rod 4 and the valve plate 3.

To be seen in FIGS. 3 to 11 are also the introduction openings 24 through which objects to be processed can be introduced into the chamber interior 25 and be removed from the process chamber 22. These introduction openings 24 can be closed by valves which are known per se and not illustrated here. As mentioned, the valve 1 for closing the flow opening 2 serves to meter a volumetric flow of a gaseous or liquid fluid which flows into the chamber interior 25 or out of the latter. Pumps and the like required for this purpose are not illustrated here but known per se.

In the description of the exemplary embodiments hereunder, only the differences in comparison to the first exemplary embodiment will be discussed. Otherwise, reference is made to the above explanations pertaining to the first exemplary embodiment, which are to be applied in an analogous manner to the second and the following exemplary embodiments.

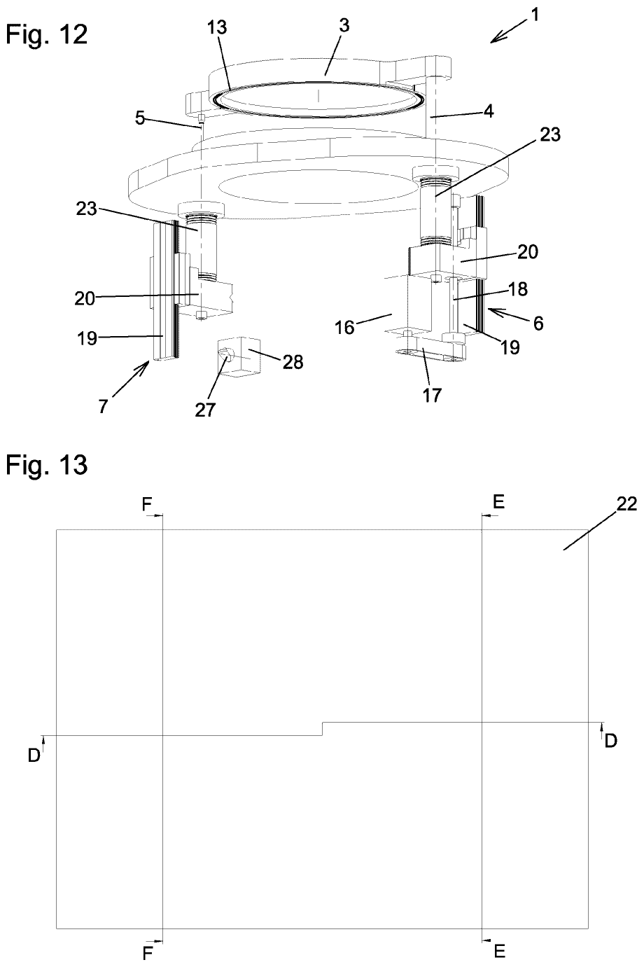

While both valve rods 4 and 5 in the first exemplary embodiment according to FIGS. 1 to 11 have the same diameter 8 and 9, respectively, and are also designed with the same stiffness in terms of a deflection transverse to their respective longitudinal extent, this is not the case in the exemplary embodiments discussed hereunder. In the variants according to FIGS. 12 to 38 it is provided that the valve rods 4 and 5 are designed with different stiffnesses in terms of a deflection transverse to their respective longitudinal extent. In these exemplary embodiments it is preferably provided that the valve rods 4 and 5 are formed from the same material, preferably from a steel or a high-grade steel. In order to design the valve rods 4 and 5 with different stiffnesses in terms of a deflection transverse to their respective longitudinal extent, it is provided in all exemplary embodiments described hereunder that the valve rods 4 and 5 at least in regions have a different diameter 8 and 9. As has already been explained at the outset, it is favorable here that the valve rod 4 which is stiffer in terms of the deflection transverse to its longitudinal extent has a modulus of resistance that is at least five times that of the other valve rod 5. In this way, the diameter 8 of the stiffer valve rod 4 is in each case favorably significantly larger than the diameter 9 of the less stiff valve rod 5.

If the temperatures in the chamber interior 25 and in the process chamber 22 change relative to one another, longitudinal variations which are thermally caused arise in the valve plate 3, or else in the valve drives 6 and 7. These different temperature-related longitudinal expansions are compensated for in these exemplary embodiments discussed hereunder by means of a corresponding deflection of the less stiff valve rod 5 in a direction transverse to its longitudinal extent. The feedthroughs 38 through the walls of the process chambers 22 and the optionally present valve seat plates 15 are favorably designed to be so large in all exemplary embodiments mentioned hereunder that there is a corresponding amount of space for the deflection of the valve rod 5. The rod seals 23 can readily compensate these deflections of the valve rod 5 which are thermally caused.

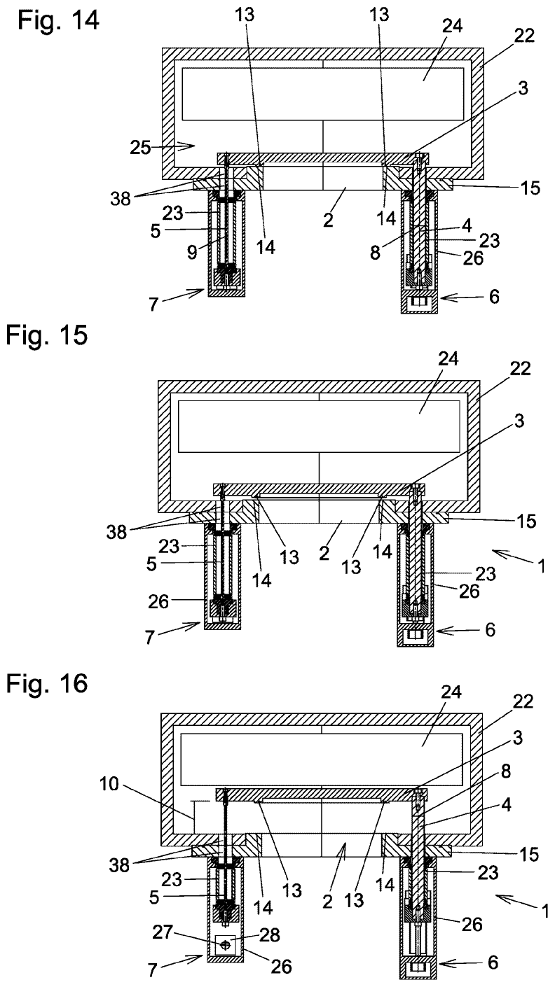

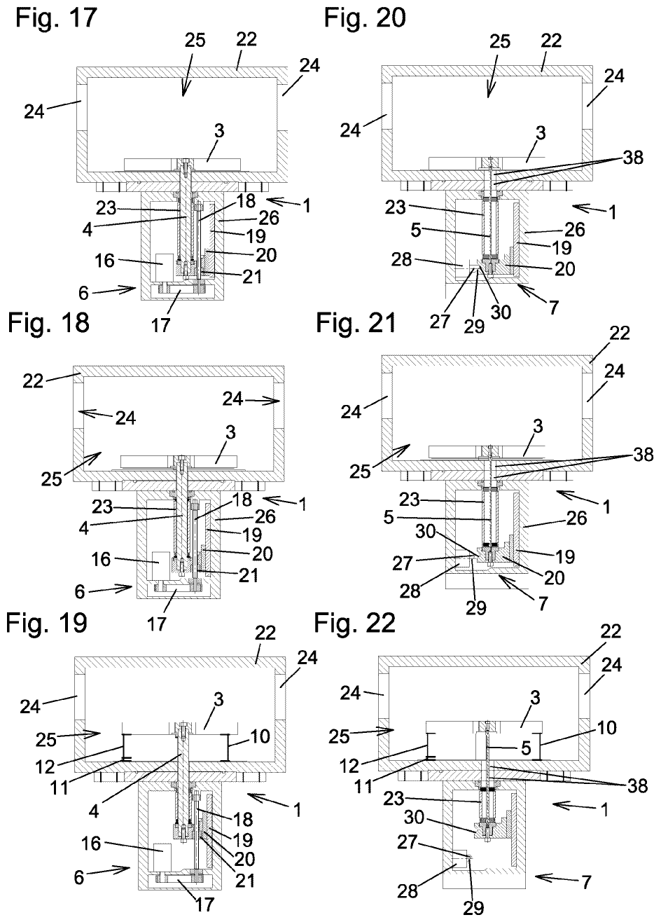

The second exemplary embodiment of the invention is shown in FIGS. 12 to 22. FIG. 12 shows the valve 1 of the second exemplary embodiment again detached from the process chamber 22, in a perspective illustration. FIG. 13 shows a top view, corresponding to that of FIG. 2, of the process chamber 22 with the section lines DD, EE and FF. FIGS. 14 to 16 again show sectional illustrations along the section line DD, wherein the valve plate 3 is in the closed position in FIG. 14, in an intermediate position in FIG. 15, and in the maximum open position in FIG. 16. FIGS. 17 to 19 show sections along the section line EE from FIG. 13, wherein FIG. 17 in turn shows the closed position, FIG. 18 an intermediate position, and FIG. 19 the maximum open position of the valve plate 3. Corresponding sections along the section line FF are shown in FIGS. 20 to 22. The valve plate 3 is again in the closed position in FIG. 20, in the intermediate position in FIG. 21, and in the maximum open position in FIG. 22.

The only difference in comparison to the first exemplary embodiment can readily be seen already in FIG. 12. While both valve rods 4 and 5 in the first exemplary embodiment have the same diameter 8 and 9 and are also designed with the same stiffness in terms of a deflection transverse to their respective longitudinal extent, this is not the case in the second exemplary embodiment. In the second exemplary embodiment, the valve rod 5 is designed to be less stiff in terms of a deflection transverse to its respective longitudinal extent than the valve rod 4. Accordingly, the valve rods 4 and 5 also have different diameters 8 and 9. The less stiff valve rod 5 is only displaceably driven over the partial distance 11 of the adjustment path 10 of the valve plate 3 toward the closed position. The valve rod 5 is uncoupled from its valve drive 7 over the remaining partial distance 12 of the adjustment path 10. The uncoupled state can be readily seen in FIGS. 12, 21 and 22. It can be seen in FIG. 20 how the valve drive 7 engages in the slide 20 of the less stiff valve rod 5 and in this way presses the valve plate 3 in the direction toward the closed position against the valve seat 14 by means of traction on the less stiff valve rod 5.

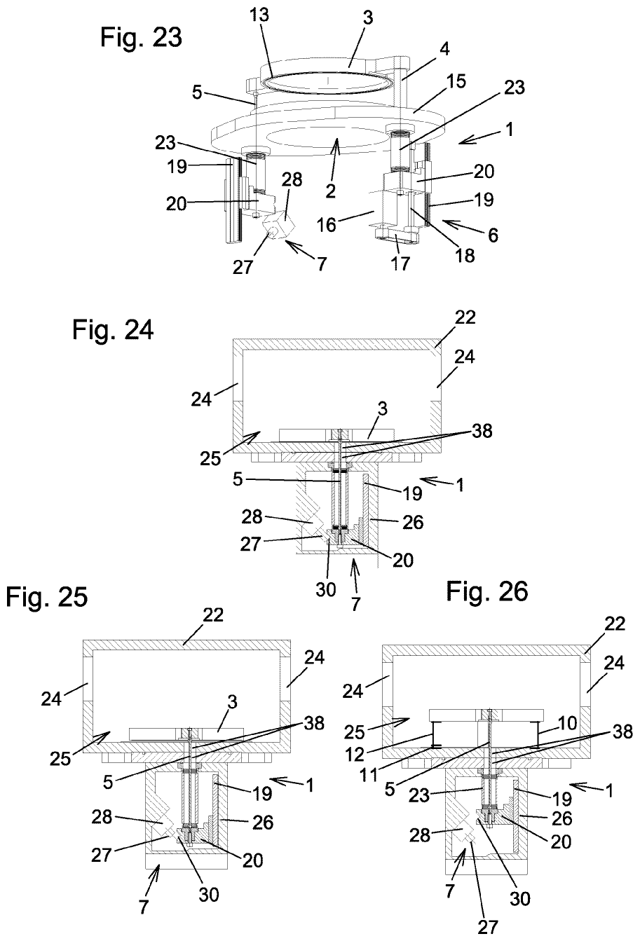

The third exemplary embodiment according to FIGS. 23 to 26 is a variation of the second exemplary embodiment according to FIGS. 12 to 22, wherein FIG. 23 is the illustration analogous to FIG. 12, and FIGS. 24 to 26 show the illustrations corresponding to FIGS. 20 to 22. The valve drive 7 of the less stiff valve rod 5 in this third exemplary embodiment likewise has a drive pin 27 and the pin drive 28. However, the oblique face 29 on the front end of the drive pin is dispensed with here. Instead, the direction of movement and the longitudinal extent of the drive pin 27 is disposed so as to be correspondingly oblique so that a displacement of the less stiff valve rod 5 in turn takes place, as shown in FIG. 24, by pressing the drive pin 27 against the mating oblique face 30 in the slide 20 of the less stiff valve rod 5, so that the valve plate 3 also in this example is moved by both valve rods 4 and 5 over the partial distance 11 in the direction toward the valve seat 14 and is pressed against the latter. The displacement of the valve plate 3 in the opening direction again takes place, as shown in FIGS. 25 and 26, exclusively by means of the valve drive 6 and the stiffer valve rod 4. The less stiff valve rod 5 is uncoupled from the valve drive 7 on this partial distance 12 of the entire adjustment path 10.

The valve drive 6 for the stiffer valve rod 4 is designed as in the first exemplary embodiment and will therefore not be explained once again. This also applies to the variants of embodiment discussed hereunder.

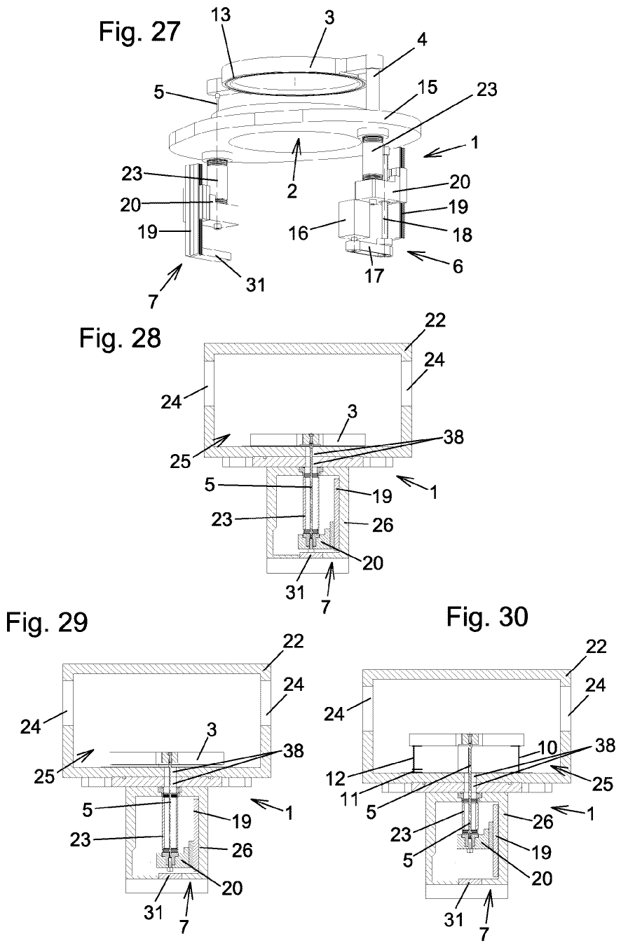

In the fourth exemplary embodiment, illustrated in FIGS. 27 to 30, the valve drive 7 for the less stiff valve rod 5 is designed in the form of a solenoid 31. The latter can be utilized for pulling the less stiff valve rod 5 downward over the partial distance 11, and thus pull the valve plate 3 to the closed position. By correspondingly reversing the polarity when opening the valve plate 3, the solenoid 31 can however also be utilized to drive the valve rod 5 over the partial distance 11 in the direction toward the opening position. Otherwise, this fourth exemplary embodiment is embodied like the third exemplary embodiment so that further explanations are unnecessary. In any case, FIG. 27 again shows a perspective illustration, and FIGS. 28 to 30 show the illustrations corresponding to FIGS. 20 to 22 of the second exemplary embodiment.

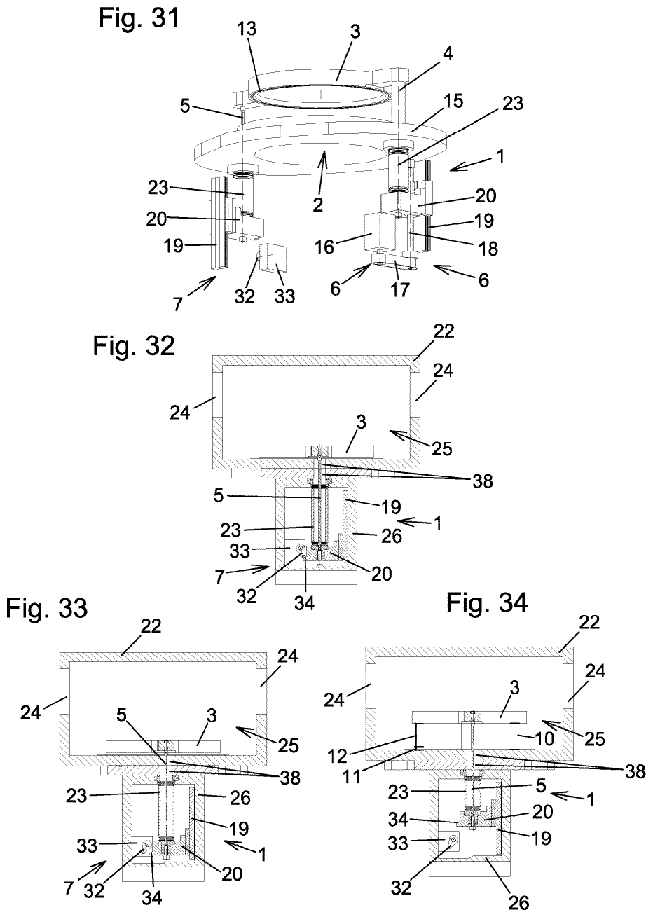

The fifth exemplary embodiment according to FIGS. 31 to 34 again differs from the second, the third and the fourth exemplary embodiments only in terms of the design embodiment of the valve drive 7 for the less stiff valve rod 5. The valve drive 7 here has a cam 32 which is pivotable by means of a cam drive 33 and which over the partial distance 11 engages in the gate guide 34 on the slide 20 so as to pull the valve rod 5, and thus also the valve plate 3, to the closed position. This can be seen in FIG. 32. FIGS. 33 and 34 show positions in which the cam 32 is released from the gate guide 34 and the valve rod 5 is thus uncoupled from the valve drive 7. Also in this variant, the valve drive 7 substantially serves to pull the valve rod 5 over the last partial distance 11 in the direction of the closed position of the valve plate 3. All other movements are implemented by means of the stiffer valve rod 4 and the valve drive 6 of the latter.

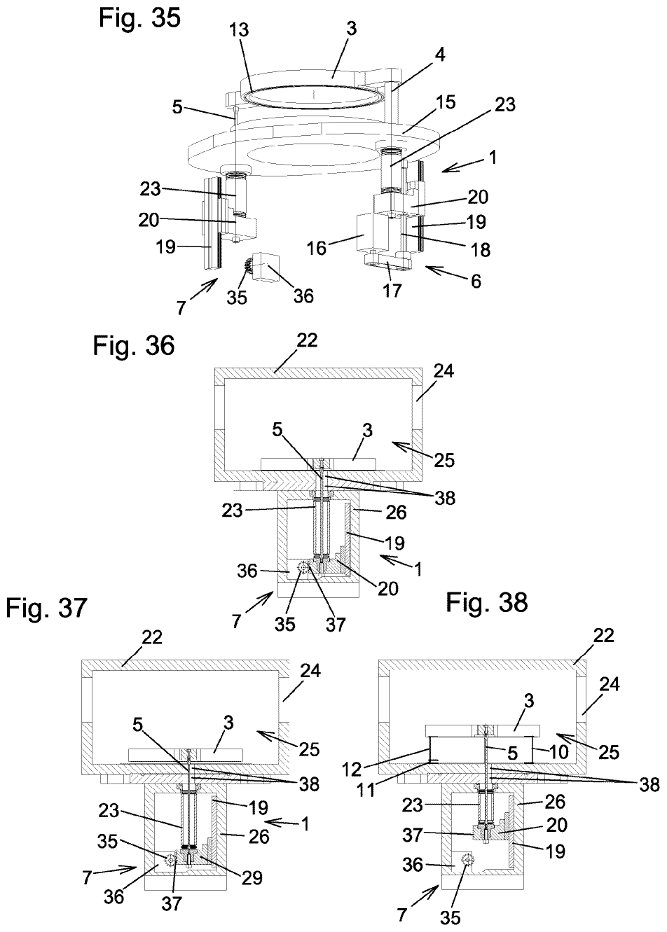

In the last exemplary embodiment according to FIGS. 35 to 38, corresponding illustrations are again shown. Here, the valve drive 7 for the less stiff valve rod 5 has a pinion 35 which is driven by means of a pinion drive 36. Said pinion 35 over the lower partial distance 11 engages in a rack 37 on the slide 20 of the less stiff valve rod 5. As a result, the less stiff valve rod 5 can be driven in the direction toward the closed position of the valve plate 3, but over the partial distance 11 also driven in the opposite direction away from the closed position. Here too, the remaining movements over the partial distance 12 are implemented solely by means of the stiffer valve rod 4 and the valve drive 6 of the latter. The types of illustrations in FIGS. 35 to 38 are chosen so as to correspond to the previously discussed exemplary embodiments.

### List of Reference Signs

1 Valve
2 Flow opening
3 Valve plate
4 Valve rod
5 Valve rod
6 Valve drive
7 Valve drive
8 Diameter
9 Diameter
10 Overall adjustment path
11 Partial distance
12 Partial distance
13 Seal
14 Valve seat
15 Valve seat plate
16 Motor
17 Drive belt
18 Spindle
19 Guide rail
20 Slide
21 Spindle nut
22 Process chamber
23 Rod seal
24 Introduction opening
25 Chamber interior
26 Drive housing
27 Drive pin
28 Pin drive
29 Oblique face
30 Mating oblique face
31 Solenoid
32 Cam
33 Cam drive
34 Gate guide
35 Pinion
36 Pinion drive
37 Rack
38 Feedthrough
39 Compensation element

1. A valve for metering a volumetric flow through a flow opening, the valve comprising:
a valve plate for closing the flow opening in a closed position of the valve;
at least two valve rods which are in each case elongate, the valve rods are fastened to the valve plate at mutually spaced apart locations;
a dedicated valve drive for each of the valve rods that linearly displaces a respective one of the valve rods so as to adjust the valve plate; and
wherein only a subset of the valve rods are driven by the respective valve drive over an entire adjustment path of the valve plate between the closed position and a maximum open position.

2. The valve as claimed in claim 1, wherein only one of the valve rods is driven by the respective valve drive over the entire adjustment path of the valve plate between the closed position and the maximum open position.

3. The valve as claimed in claim 1, wherein at least one of the valve rods is driven by the respective valve drive only over a partial distance of the adjustment path of the valve plate (3) toward the closed position and away from the closed position.

4. The valve as claimed in claim 3, wherein the at least one of the valve rods, which is driven by the respective valve drive only over the partial distance of the adjustment path of the valve plate toward the closed position and away from the closed position, is uncoupled from the respective valve drive on another partial distance of the adjustment path of the valve plate toward the maximum open position and away from the maximum open position.

5. The valve as claimed in claim 1, wherein that the valve rods are formed from a same material.

6. The valve as claimed in claim 1, wherein the valve drives of the valve rods are mutually synchronized over partial distances of the adjustment path on which said valve rods are conjointly active.

7. The valve as claimed in claim 1, wherein that the valve rods at least in regions have a different diameter.

8. The valve as claimed in claim 1, wherein the respective valve rods are designed with a different stiffness in terms of a deflection transverse to a respective longitudinal extent thereof.

9. The valve as claimed in claim 8, the valve rod which is stiffer in terms of the deflection transverse to longitudinal extent thereof has a modulus of resistance that is at least five times that of the other valve rod.

10. The valve as claimed in claim 8, wherein only the valve rod which is stiffer in terms of the deflection transverse to the longitudinal extent thereof is driven by the respective valve drive over the entire adjustment path of the valve plate between the closed position and the maximum open position.
